(19) United States
(12) Patent Application Publication
(10) Pub. No.: US 2016/0195057 A1
(43) Pub. Date: Jul. 7, 2016

(54) LASER IGNITION SYSTEM FOR GASEOUS FUEL-POWERED ENGINE

(71) Applicant: Caterpillar Inc., Peoria, IL (US)

(72) Inventors: David M. Ginter, Commerce Township, MI (US); Arnold M. Kim, Peoria, IL (US); Jaswinder Singh, Dunlap, IL (US); Kenth I. Svensson, Peoria, IL (US)

(73) Assignee: Caterpillar Inc., Peoria, IL (US)

(21) Appl. No.: 15/067,188

(22) Filed: Mar. 11, 2016

(51) Int. Cl. F02P 23/04; F02P 15/08

(52) U.S. Cl. CPC F02P 23/04; F02P 15/08

(57) ABSTRACT

A gaseous fuel-powered engine includes a fuel injector configured to selectively inject a plurality of gas plumes into the combustion chamber, and a laser ignition system configured to selectively ignite the gas plumes within the combustion chamber. The laser ignition system includes a laser source configured to generate at least one laser beam, and a beam splitter for splitting the laser beam into a plurality of partial laser beams. A focusing unit is provided to direct each partial laser beam to corresponding focal points in the gas plumes within the combustion chamber. A controller is configured to determine an operating state of the gaseous fuel-powered engine, regulate an intensity of each partial laser beam, and operate the focusing unit for directing the partial laser beams within the combustion chamber to ignite the gas plumes at the focal points during injection of the gas plumes within the combustion chamber.

### TECHNICAL FIELD

The present disclosure relates to a gaseous fuel-powered engine, and in particular, to a laser ignition system for the gaseous fuel-powered engine.

### BACKGROUND

Gaseous fuel-powered engines are used in various heavy machinery applications or power generation applications. The gaseous fuel-powered engines generate power by combustion of gaseous fuels, such as natural gas, biogas, coal gas, and producer gas. Typically, in a natural gas-based gaseous fuel-powered engine, diesel fuel and natural gas are injected into a combustion chamber. In the natural gas-based gaseous fuel-powered engine, diesel ignites due to high pressure and temperature created within the combustion chamber during operation thereof, and thereafter, natural gas is ignited by combustion of the diesel fuel. Such natural gas-based gaseous fuel-powered engines require a fuel injection system for introducing diesel, and another fuel injection system for introducing natural gas into the combustion chamber. This may increase the cost and design complexity of such gaseous fuel-powered engines.

In other gaseous fuel-powered engines, laser based ignition systems are used to ignite a mixture of gaseous fuel and air. The laser based ignition systems typically include a laser source that provides a pulsed laser for igniting the mixture of gaseous fuel and air within a combustion chamber of such gaseous fuel-powered engines.

For reference, U.S. Pat. No. 8,746,196 (the '196 patent) discloses a laser spark plug for an internal combustion engine. According to a laser based ignition system of the internal combustion engine, at least one volume Bragg grating element is situated in a beam path of the laser spark plug. In order to implement spatial multipoint ignition events, in which it is possible to emit laser ignition pulses simultaneously to at least two different ignition points, the volume Bragg grating element is configured as a beam splitter. However, the laser based ignition system, as disclosed in the '196 patent, may be ineffective in igniting fuel under various operating conditions of the internal combustion engine. This may cause degradation in performance of the internal combustion engine and may also lead to internal combustion engine failure.

### SUMMARY OF THE DISCLOSURE

In one aspect of the present disclosure, a gaseous fuel-powered engine is provided. The gaseous fuel-powered engine includes an engine block, an engine head disposed on an engine block, and a combustion chamber defined substantially within the engine block. The gaseous fuel-powered engine also includes a fuel injector provided on the engine head to selectively inject a plurality of gas plumes into the combustion chamber. The gaseous fuel-powered engine further includes a laser ignition system provided on the engine head. The laser ignition system is configured to selectively ignite the plurality of gas plumes within the combustion chamber. The laser ignition system includes a laser source configured to generate at least one laser beam. The laser ignition system also includes a beam splitter optically associated with the laser source for splitting the laser beam into a plurality of partial laser beams. The laser ignition system also includes a focusing unit optically associated with the beam splitter and the combustion chamber. The focusing unit is configured to direct each partial laser beam of the plurality of laser beams to corresponding focal points in the plurality of gas plumes within the combustion chamber. The laser ignition system also includes a controller in communication with the laser source and the focusing unit. The controller is configured to determine an operating state of the gaseous fuel-powered engine. The controller is also configured to regulate, based on the operating state of the gaseous fuel-powered engine, an intensity of each partial laser beam of the plurality of partial laser beams. The controller is also configured to operate, based on the operating state of the gaseous fuel-powered engine, the focusing unit for directing the plurality of the partial laser beams within the combustion chamber to move the focal points in the plurality of gas plumes with the combustion chamber. Further, the plurality of partial laser beams ignites the plurality of gas plumes at the focal points during injection of the plurality of gas plumes within the combustion chamber.

### BRIEF DESCRIPTION OF THE DRAWINGS

FIG. 1 is a schematic view of a portion of an gaseous fuel-powered engine having a laser based ignition system, according to one embodiment of the present disclosure;

FIG. 2 is a bottom view of a combustion chamber of the gaseous fuel-powered engine of FIG. 1;

FIG. 3 is a schematic view of a laser ignition system of the gaseous fuel-powered engine, according to another embodiment of the present disclosure; and

FIG. 4 is a schematic view of a laser ignition system of the gaseous fuel-powered engine, according to yet another embodiment of the present disclosure.

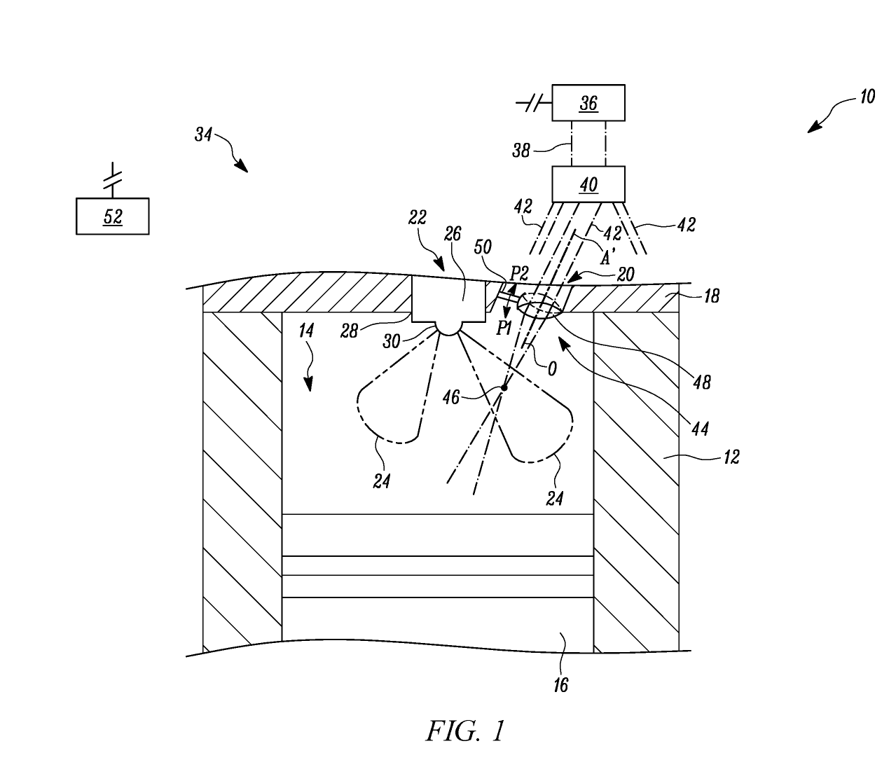

### DETAILED DESCRIPTION

Wherever possible, the same reference numbers will be used throughout the drawings to refer to the same or the like parts. FIG. 1 is a schematic view of a portion of a gaseous fuel-powered engine 10. The gaseous fuel-powered engine 10 is any internal combustion engine which runs on gaseous fuel for example, natural gas. The gaseous fuel-powered engine 10 may be used to power various types of machines associated with an industry including, but not limited to, transportation, construction, mining, agriculture, forestry, waste management, and material handling. The gaseous fuel-powered engine 10 may be a multi-cylinder type engine or a single-cylinder type engine. While FIG. 1 depicts a single-cylinder engine 10, it will be appreciated that the embodiments described herein may be used in multi-cylinder type engines of various configurations, such as, in-line, V-type, radial, and rotary, etc.

The gaseous fuel-powered engine 10 includes an engine block 12 and a combustion chamber 14 defined substantially within the engine block 12. The combustion chamber 14 receives a piston 16 that reciprocates between a Top Dead Center (TDC) position and a Bottom Dead Center (BDC) position within the combustion chamber 14. A connecting rod (not shown) connects the piston 16 to a crankshaft (not shown) of the gaseous fuel-powered engine 10 such that the reciprocating motion of the piston 16 between the top dead center position and the bottom dead center position results in a rotational motion of the crank shaft. As such, an engine speed of the gaseous fuel-powered engine 10 may be defined based on the rotational speed of the crankshaft.

The gaseous fuel-powered engine 10 also includes an engine head 18 mounted on the engine block 12. The engine head 18 defines a plurality of recesses, such as a recess 20 (shown in FIG. 1). In one example, the engine head 18 defines six recesses such as the recess 20, which are in communication with the combustion chamber 14. The engine head 18 defines intake ports (not shown) and exhaust ports (not shown) therein. The intake ports allow intake of air into the combustion chamber 14 for combustion of gaseous fuel. In various examples, various diluents and/or gases may also be mixed with air during injection of air. The exhaust ports allow removal of exhaust gases produced due to the combustion of fuel and air from the combustion chamber 14. An intake valve (not shown) is provided within each of the intake ports to selectively control a flow of the air into the combustion chamber 14. An exhaust valve (not shown) is also provided within each of the exhaust ports to selectively control a flow of exhaust gases through a corresponding exhaust port.

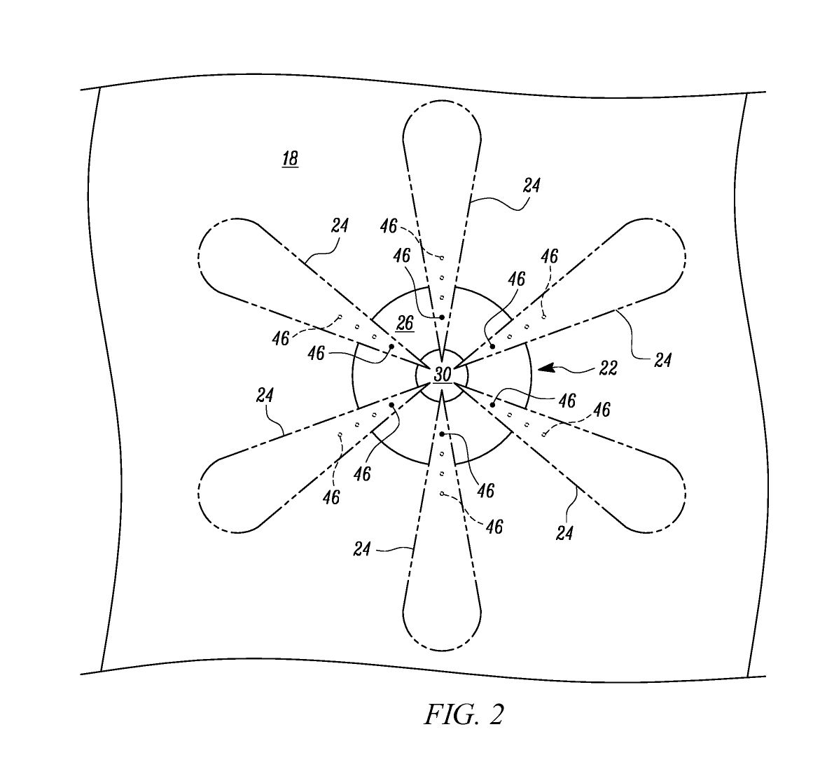

FIG. 2 is a bottom view of the combustion chamber 14 of the gaseous fuel-powered engine 10. Referring to FIGS. 1 and 2, the gaseous fuel-powered engine 10 includes a fuel injector 22 provided on the engine head 18. The fuel injector 22 selectively injects a plurality of gas plumes 24 into the combustion chamber 14 (shown in FIG. 1). In one example, the fuel injector 22 injects six gas plumes 24 (shown in FIG. 2). The fuel injector 22 includes a body 26 partially received within an opening 28 of the engine head 18 and partially received within the combustion chamber 14. The fuel injector 22 also includes a tip portion 30 extending into the combustion chamber 14. The tip portion 30 defines six nozzle passages (not shown) that are adapted to introduce the gas plumes 24 into the combustion chamber 14. However, it is contemplated that the fuel injector 22 may include any number of nozzle passages defined in the tip portion 30 for injecting a fewer or a larger number of gas plumes 24 into the combustion chamber 14. Also, the fuel injector 22 may be hydraulically, pneumatically, mechanically or electronically operated to inject the gas plumes 24 into the combustion chamber 14. Further, an air-fuel ratio may be defined based on a volume of air introduced in the combustion chamber 14 and a volume of gaseous fuel injected into the combustion chamber 14.

As shown in FIGS. 1 and 2, the gaseous fuel-powered engine 10 includes a laser ignition system 34. The laser ignition system 34 is provided on the engine head 18 of the gaseous fuel-powered engine 10. The laser ignition system 34 is capable of selectively igniting the gas plumes 24 within the combustion chamber 14 based on an operating state of the gaseous fuel-powered engine 10. In various examples, the operating state may be defined based on the parameters such as an air-fuel ratio, an engine load, engine emissions, an engine temperature, the engine speed or a combination thereof. Further, it will be appreciated that various other or additional parameters may also be used to determine the operating state of the gaseous fuel-powered engine 10.

The laser ignition system 34 includes a laser source 36. The laser source 36 generates at least one laser beam 38. In one example, the laser source 36 generates one laser beam 38. The laser beam 38 acts as a heat source for igniting the gas plumes 24. The laser beam 38 has a first intensity ‘I1’ that can be changed, based on the operating state of the gaseous fuel-powered engine 10. The laser beam 38 can operate in different modes such as, a continuous mode of operation and a pulsed mode of operation, based on a frequency of the laser beam 38. The laser beam 38 in the continuous mode of operation may also be pulsed at a pre-determined frequency to obtain the laser beam 38 in the pulsed mode of operation.

The laser ignition system 34 also includes a beam splitter 40 optically associated with the laser source 36. The beam splitter 40 is positioned downstream of the laser source 36 with respect to a direction of the laser beam 38. The beam splitter 40 is configured to split the laser beam 38 into a plurality of partial laser beams 42 (three are shown in FIG. 1). In an example, the beam splitter 40 includes a pair of prisms (not shown) coupled to each other at respective bases. In another example, the beam splitter 40 may include an array of mirrors including at least one partially reflecting mirror. In yet another example, the beam splitter 40 may include a partially mirrored prism. The beam splitter 40 splits the laser beam 38 into six partial laser beams 42. Each of the partial laser beams 42 has a second intensity ‘I2’. The second intensity ‘I2’ may be equal to or different from the first intensity ‘I1’ of the laser beam 38.

In order to direct each of the partial laser beams 42 in the combustion chamber 14, the laser ignition system 34 includes a focusing unit 44, optically associated with the beam splitter 40, and the combustion chamber 14. The focusing unit 44 directs each of the partial laser beams 42 to corresponding focal points 46 (shown in FIG. 2) in the gas plumes 24 during injection of the gas plumes 24 into the combustion chamber 14.

The focusing unit 44 includes a plurality of lenses 48 (one is shown in FIG. 1) positioned within the recesses 20 of the engine head 18. In various examples, the focusing unit 44 may include other types of optical lenses, such as convex lenses, piano-convex lenses, bi-concave lenses, plano-concave lenses, positive meniscus lenses, negative meniscus lenses, etc. Each of the lenses 48 is also positioned within a path of a corresponding partial laser beam 42. The lens 48 is coupled to the engine head 18 by an actuating mechanism 50 such that the lens 48 can be tilted between a first position ‘P1’ and a second position ‘P2’. At the first position ‘P1’, the lens 48 is tilted towards the combustion chamber 14, thereby moving the focal point 46 to locations adjacent to the piston 16 within the gas plumes 24. In the second position ‘P2’, the lens 48 (illustrated in phantom lines) is tilted away from the combustion chamber 14, thereby moving the focal point 46 to locations adjacent to the fuel injector 22 within the gas plumes 24. Further, the actuating mechanism 50 also tilts the lens 48 within the recess 20 in order to co-axially align the partial laser beam 42 with an optical axis OA′ of the lens 48. The actuating mechanism 50 may be electrically or mechanically operated to tilt the lens 48. Examples of the actuating mechanism 50 may include, but not limited to, a solenoid, a spring member, a motor, etc.

Further, the lens 48 directs the partial laser beam 42 at the focal point 46 on the optical axis OA′ within the gas plume 24. The partial laser beam 42 at the focal point 46 generates an ignition temperature ‘T1’ within the gas plume 24 in order to ignite the gas plume 24 in presence of air. Similarly, other partial beams 42 ignite the respective gas plumes 24 at corresponding focal points 46. Thus, the gaseous fuel inside the combustion chamber 14 is ignited at multiple focal points 46 (see FIG. 2) by the partial laser beams 42. Moreover, the ignition temperature ‘T1’ may also be increased or decreased by varying at least one of the first intensity ‘I1’ and the second intensity ‘I2’ of the laser beam 38 and the partial laser beams 42, respectively. Although each gas plume 24 is ignited by a corresponding focal point 46, it is contemplated that one or more of the gas plumes 24 may also be ignited due to ignition of adjacent gas plumes 24 by the corresponding partial laser beam 42. In such a case, fewer partial laser beams 42, i.e. less than six, may be used to ignite the gas plumes 24.

For the purpose of simplicity, the focusing unit 44 is explained with reference to one lens 48. However, it should be noted that the description provided above is equally applicable to other lenses 48 of the focusing unit 44.

As shown in FIG. 1, the laser ignition system 34 includes a controller 52 in communication with the laser source 36 and the focusing unit 44. The controller 52 is also in communication with one or more sensors (not shown) associated with the gaseous fuel-powered engine 10. The controller 52 is capable of receiving inputs, such as, but not limited to, the engine load, the engine speed, the air fuel ratio, a fuel injection rate, the engine temperature, and the engine emissions, from the sensors. The controller 52 is also capable of determining the operating state of the gaseous fuel-powered engine 10 based on the received inputs. Based on the determined operating state, the controller 52 also operates at least one of the laser source 36, the beam splitter 40, and the focusing unit 44 to ignite the gas plumes 24. More specifically, the controller 52 regulates the first intensity ‘I1’ of the laser beam 38 based on the operating state. If, for example, the gaseous fuel-powered engine 10 is running at a lean air fuel ratio, the controller 52 may operate the laser source 36 to increase the first intensity ‘I1’ of the laser beam 38 and the partial laser beams 42 for igniting the lean air fuel mixture.

The controller 52 also operates, based on the operating state of the gaseous fuel-powered engine 10, the focusing unit 44 for directing the partial laser beams 42 to move the focal points 46. More specifically, the controller 52 actuates the actuating mechanisms 50 for tilting the lenses 48 in order to change corresponding focal points 46 within the gas plumes 24. The controller 52 also changes a direction of the partial laser beams 42 to coaxially align the corresponding optical axes OA′ of the tilted lens 48 with the partial laser beams 42 for changing the focal points 46. If, for example, the gaseous fuel-powered engine 10 is running at a lean air fuel ratio, the controller 52 may tilt the lens 48 to the first position ‘P1’ to move the focal points 46 to locations proximal to the piston 16 during a compression stroke of the gaseous fuel-powered engine 10. Further, if the gaseous fuel-powered engine 10 is running at a rich air fuel ratio, the controller 52 may move the lens 48 to the second position ‘P2’ to accordingly move the focal points 46 with respect to the fuel injector 22. Furthermore, the controller 52 may also change a direction of the partial laser beams 42 to align the optical axis OA′ and the partial laser beams 42 based on the engine operating state.

The controller 52 includes various components such as a memory unit, a secondary storage device, and a processor, for example a central processing unit. It will be appreciated that the controller 52 may include additional or different components. The controller 52 may be a dedicated system for performing the functions described above or may readily embody a general machine or power system microprocessor capable of controlling numerous machine or power system functions. The controller 52 may be associated with various other known circuits such as, for example, a power supply circuitry, a signal conditioning circuitry, and a solenoid driver circuitry.

For explanation purposes, the lens 48 is shown to move between the first position ‘P1’ and the second position ‘P2’, however, it will be contemplated that the lens 48 may be moved to any positions defined between the first position ‘P1’ and the second position ‘P2’.

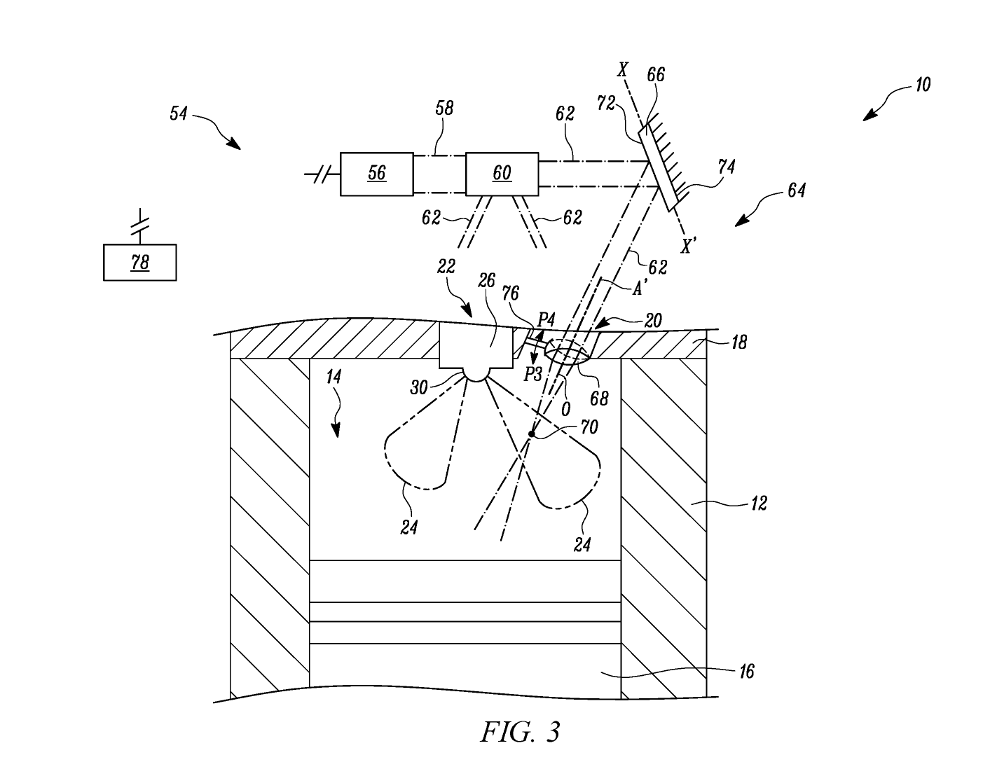

FIG. 3 is a schematic view of a laser ignition system 54 of the gaseous fuel-powered engine 10, according to another embodiment of the present disclosure. Similar to the laser ignition system 34 of FIG. 1, the laser ignition system 54 includes a laser source 56 for generating a laser beam 58, and a beam splitter 60 for splitting the laser beam 58 into a plurality of partial laser beams 62 (three are shown in FIG. 3). The laser ignition system 54 includes a focusing unit 64 for directing the partial laser beams 62 at corresponding focal points 70 (only one shown in FIG. 3) in the gas plumes 24. However, in the present embodiment, the focusing unit 64 includes multiple mirrors 66 and multiple lenses 68 optically associated with the mirrors 66 and positioned within the recesses 20. Each of the mirrors 66 and the lens 68 together direct each of the partial laser beams 62 to a corresponding focal point 70 in the gas plume 24. For illustration purposes, one mirror 66 and one lens 68 are shown. The mirror 66 is positioned within a path of the partial laser beam 62 and rotatably mounted on the engine head 18. The mirror 66 is rotatable about a central axis XX′ thereof such that a direction of the partial laser beam 62 may be changed based on requirements. The mirror 66 includes a reflective surface 72 and a non-reflective surface 74.

Although, in the illustrated embodiment, the focusing unit 64 includes multiple lenses 68, it should be contemplated that other types of optical lenses, such as piano-convex lenses, bi-concave lenses, piano-concave lenses, positive meniscus lenses, negative meniscus lenses, etc. may also be used in various embodiments.

Further, the lens 68 is optically associated with the mirror 66 and the combustion chamber 14. The lens 68 has an optical axis OA′. The lens 68 is coupled to the engine head 18 by an actuating mechanism 76 such that the lens 68 can be tilted within the recess 20 between a first position ‘P3’ and a second position ‘P4’. At the first position ‘P3’, the lens 68 is tilted towards the combustion chamber 14, thereby moving the focal point 70 to locations adjacent to the piston 16. At the second position ‘P4’, the lens 68 (illustrated in phantom lines) is tilted away from the combustion chamber 14, thereby moving the focal point 70 to locations adjacent to the fuel injector 22. The actuating mechanism 76 tilts the lens 68 within the recess 20 in order to co-axially align the partial laser beam 62 with an optical axis OA′ of the lens 68. The actuating mechanism 76 may be operated to tilt the lens 68. Examples of the actuating mechanism 76 may include, but is not limited to, a solenoid, a spring member, a hydraulic or pneumatic actuator, a hydraulic, an electric motor, a pneumatic motor, etc.

For explanation purposes, the lens 68 is shown to move between the first position ‘P3’ and the second position ‘P4’, however, it will be contemplated that the lens 68 may be moved to any positions defined between the first position ‘P3’ and the second position ‘P4’.

In operation, the partial laser beam 62 after reflecting from the reflective surface 72 of the mirror 66 propagates towards the lens 68. Thereafter, the lens 68 directs the partial laser beam 62 at the focal point 70 in the gas plume 24 within the combustion chamber 14 during injection thereof. The partial laser beam 62 at the focal point 70 generates an ignition temperature ‘T2’ within the gas plume 24 in order to ignite the gas plume 24 in presence of air. Similarly, other partial beams 62 ignite the respective gas plumes 24 at corresponding focal points 70. Thus, the gaseous fuel inside the combustion chamber 14 is ignited at multiple focal points 70 by the partial laser beams 62 within the gas plumes 24 during injection thereof.

The laser ignition system 54 also includes a controller 78 in communication with the laser source 56 and the focusing unit 64. In particular, the controller 78 is in operative communication with the mirror 66, the lens 68, and the actuating mechanism 76 of the focusing unit 64. The controller 78 is also in communication with the sensors associated with the gaseous fuel-powered engine 10. The controller 78 receives inputs, such as, but not limited to, an engine load, an engine speed, an air fuel ratio, a fuel injection rate, an engine temperature, and engine emissions, from the sensors. The controller 78 further determines the operating state of the gaseous fuel-powered engine 10 based on the received inputs. Based on the determined operating state, the controller 78 operates at least one of the laser source 56, the mirror 66, the actuating mechanism 76, and the lens 68 to ignite the gas plumes 24.

The controller 78 also regulates an intensity of each of the partial laser beams 62 based on the operating state. The controller 78 also operates, based on the operating state of the gaseous fuel-powered engine 10, the focusing unit 64 for directing the partial laser beams 62 to change the focal points 70 in the gas plumes 24 within the combustion chamber 14. More specifically, the controller 78 actuates the actuating mechanisms 76 for tilting the lenses 68 in order to move the focal points 70 within the gas plumes 24. The controller 78 also rotates the mirror 66 to coaxially align the partial laser beam 62 with the optical axis OA′ of the lens 68.

For the purpose of simplicity, the focusing unit 64 is explained with reference to one mirror 66 and one lens 68. However, it should be noted that the description provided above is equally applicable to other lenses (not shown) and other mirrors (not shown) of the focusing unit 64.

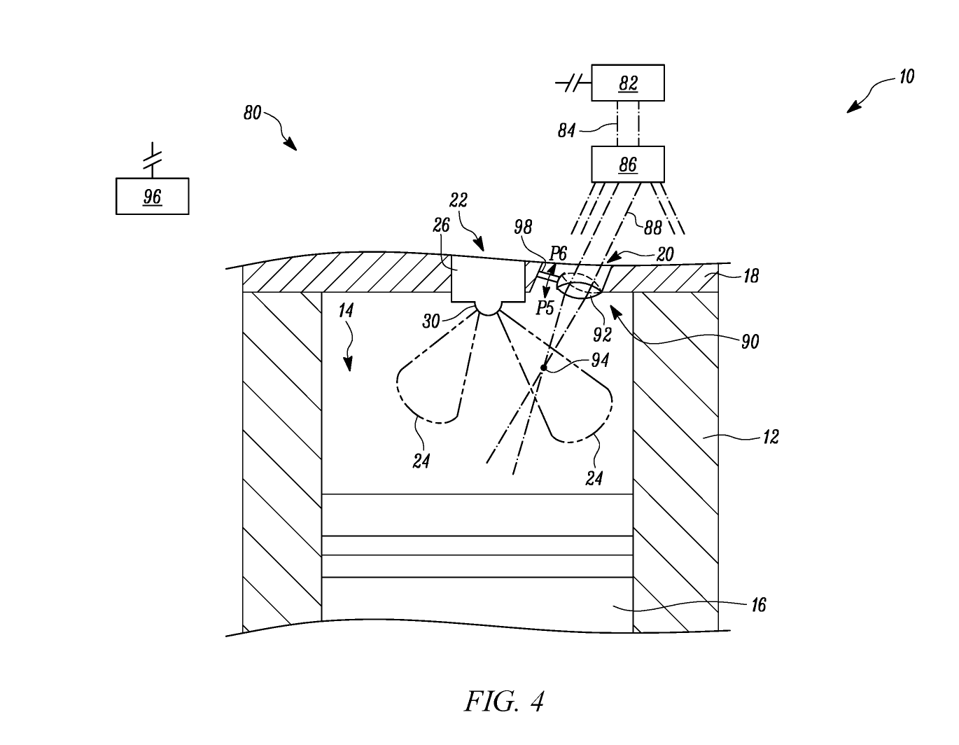

FIG. 4 is a schematic view of a laser ignition system 80 of the gaseous fuel-powered engine 10, according to yet another embodiment of the present disclosure. Similar to the laser ignition system 34 of FIG. 1, the laser ignition system 80 includes a laser source 82 for generating a laser beam 84, and a beam splitter 86 for splitting the laser beam 84 into a plurality of partial laser beams 88 (one shown in FIG. 4). The laser ignition system 80 also includes a focusing unit 90 for directing the partial laser beams 88 at corresponding focal points 94. In the present embodiment, the focusing unit 90 includes six liquid lenses 92 disposed within the paths of each partial laser beam 88. Each of the liquid lenses 92 has a variable focal length that may be varied based on requirements to change the focal points 94 within the gas plumes 24. The liquid lenses 92 are positioned within the recesses 20 of the engine head 18. In one example, each of the liquid lenses 92 may also be rotatable between a first position ‘P5’ and a second position ‘P6’, via an actuating mechanism 98, in order to move the focal points 94 proximal to or distal from the piston 16. Further, the liquid lenses 92 are optically associated with the beam splitter 86 and the combustion chamber 14. In one example, each of the liquid lenses 92 may includes a transparent wall member and a layer of two or more fluids stored within the transparent wall member. The liquid lenses 92 may be dielectrically or electro-magnetically actuated to direct the partial laser beams 80 at multiple focal points 94.

The partial laser beams 88 at the corresponding focal point 94 generates an ignition temperature ‘T3’ within the gas plume 24 in order to ignite the gas plume 24 in presence of air. Thus, the gaseous fuel inside the combustion chamber 14 is ignited at multiple focal points 94 by the partial laser beams 88 within the gas plumes 24 during injection thereof.

For explanation purposes, the liquid lenses 92 is shown to move between corresponding first positions ‘P5’ and corresponding second positions ‘P6’, however, it will be contemplated that the liquid lenses 92 may be moved to any positions defined between the first positions ‘P5’ and the second positions ‘P6’.

The laser ignition system 80 also includes a controller 96 in communication with the laser source 82 and the focusing unit 90. The controller 96 is also in communication with the sensors of the gaseous fuel-powered engine 10. The controller 96 receives inputs, such as, but not limited to, an engine load, an engine speed, an air fuel ratio, an engine temperature, and engine emissions, from the sensors. The controller 96 further determines the operating state of the gaseous fuel-powered engine 10, based on the received inputs. Based on the determined operating state, the controller 96 operates the laser source 82 and the liquid lenses 92, to ignite the gas plumes 24. More specifically, the controller 96 regulates an intensity of each of the partial laser beams 88, based on the operating state of gaseous fuel-powered engine 10. The controller 96 also operates, based on the operating state of the gaseous fuel-powered engine 10, the liquid lenses 92 to move the focal points 94 in the gas plumes 24 within the combustion chamber 14. In one example, the controller 96 may regulate a voltage across the liquid lenses 92 in order to change the focal points 94 within the gas plumes 14.

Although the gaseous fuel-powered engine 10 is described with reference to natural gas based gaseous fuel-powered engine 10, it will be appreciated that the gaseous fuel-powered engine 10 may also utilize other gaseous fuels, such as petroleum gas, coal gas, producer gas or a combination thereof. Additionally, the gaseous fuel-powered engine 10 may include various other components, for example, an air filter (not shown) and a turbo charger (not shown) through which the air may pass before entering the combustion chamber 14. Also, a common power source (not shown), for example, a battery, may also be provided to power the controllers 52, 78, 96, the focusing units 44, 64, 90, and the laser sources 36, 56, 82.

Further, in various applications, the fuel injector 22 may be adapted to inject fewer than or more than six gas plumes 24. Accordingly, based on a number of gas plumes, the beam splitters 40, 60, 86 of the laser ignition systems 34, 54, 80 may be configured to split the laser beam 38, 58, 84 to obtain the desired number of partial laser beams 42, 62, 88. Moreover, one or more optical fibers may also be provided within the laser ignition systems 34, 54, 80.

Various embodiments disclosed herein are to be taken in the illustrative and explanatory sense, and should in no way be construed as limiting of the present disclosure. All joinder references e.g., attached, affixed, coupled, engaged, connected, and the like are only used to aid the reader's understanding of the present disclosure, and may not create limitations, particularly as to the position, orientation, or use of the systems, processes, and/or methods disclosed herein. Therefore, joinder references, if any, are to be construed broadly. Moreover, such joinder references do not necessarily infer that two elements are directly connected to each other. Moreover, expressions such as “including”, “comprising”, “incorporating”, “consisting of”, “containing”, “having”, and the like, used to describe and claim the present disclosure, are intended to be construed in a non-exclusive manner, namely allowing for components or elements not explicitly described also to be present.

### INDUSTRIAL APPLICABILITY

The laser ignition systems 34, 54, 80 of the present disclosure may be configured to ignite the gaseous fuel in the combustion chamber 14 of the gaseous fuel-powered engine 10. The controllers 52, 78, 96 determine the operating state based on the received inputs, such as, but not limited to, engine load, engine speed, air fuel ratio, engine temperature, and engine emissions. The controllers 52, 78, 96 regulate the intensity of the partial laser beams 42, 62, 88, based on the operating state. The controllers 52, 78, 96 operates the focusing units 44, 64, 90 to change the corresponding focal points 46, 70, 94 in the corresponding gas plumes 24 within the combustion chamber 14, based on the operating state.

The laser ignition systems 34, 54, 80 also vary timings of ignition events in the combustion chamber 14 by changing the corresponding focal points 46, 70, 94 within the gas plumes 14, based on the operating state. For example, during a compression stroke of the gaseous fuel-powered engine 10, the controllers 52, 78, 96 may move the corresponding focal points 46, 70, 94 proximate to the piston 16 within the corresponding gas plumes 24. Thereafter, the controllers 52, 78, 96 may operate the focusing units 44, 64, 90 to change the focal points 46, 70, 94 to locations adjacent to the fuel injector 22, when the piston 16 is at the TDC position. Further, the controllers 52, 78, 96 may also vary the intensities of the partial laser beams 42, 62, 88 in order to provide more energy to ignite the lean air fuel mixture. Moreover, during an expansion stroke of the gaseous fuel-powered engine 10, the controllers 52, 78, 96, accordingly directs the partial laser beams 42, 62, 88 within the corresponding gas plumes to move the focal points 46, 70, 94 proximate to the piston 16. Thus, optimum ignition of the gaseous fuel is obtained in various operating states of the gaseous fuel-powered engine 10.

With the use of the laser ignition systems 34, 54, 80, complexity of the gaseous fuel-powered engine 10 is reduced as an auxiliary fuel to ignite the gaseous fuel is not required. Further, as the laser beams 38, 58, 84, from the single laser sources 36, 56, 82 are split into multiple partial laser beams 42, 62, 88 to ignite the gas plumes 24, operations of the laser ignition systems 34, 54, 80 are simplified.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A gaseous fuel-powered engine having an engine block, an engine head disposed on the engine block, and a combustion chamber defined substantially within the engine block, the gaseous fuel-powered engine comprising:
a fuel injector provided on the engine head to selectively inject a plurality of gas plumes into the combustion chamber; and
a laser ignition system provided on the engine head, the laser ignition system being configured to selectively ignite the plurality of gas plumes within the combustion chamber, the laser ignition system including:
a laser source configured to generate at least one laser beam;
a beam splitter optically associated with the laser source for splitting the laser beam into a plurality of partial laser beams;
a focusing unit optically associated with the beam splitter and the combustion chamber, the focusing unit being configured to direct each partial laser beam of the plurality of partial laser beams to corresponding focal points in the plurality of gas plumes within the combustion chamber; and
a controller in communication with the laser source and the focusing unit, wherein the controller is configured to:
determine an operating state of the gaseous fuel-powered engine;
regulate, based on the operating state of the gaseous fuel-powered engine, an intensity of each partial laser beam of the plurality of partial laser beams; and
operate, based on the operating state of the gaseous fuel-powered engine, the focusing unit for directing the plurality of partial laser beams to move the focal points in the plurality of gas plumes within the combustion chamber,
wherein the plurality of partial laser beams ignite the plurality of gas plumes at the focal points during the injection of the plurality of gas plumes within the combustion chamber.
